(19) United States
(12) Patent Application Publication
(10) Pub. No.: US 2025/0360819 A1
(43) Pub. Date: Nov. 27, 2025

(54) BIDIRECTIONAL VEHICLE CHARGING CIRCUIT FOR GENERATING TWO DIFFERENT VOLTAGES

(71) Applicant: Schaeffler Technologies AG & Co. KG, Herzogenaurach (DE)

(72) Inventors: Franz Pfeilschifter, Walderbach (DE); Martin Götzenberger, Ingolstadt (DE)

(73) Assignee: Schaeffler Technologies AG & Co. KG, Herzogenaurach (DE)

(21) Appl. No.: 19/292,508

(22) Filed: Aug. 6, 2025

Related U.S. Application Data
(63) Continuation of application No. PCT/EP2024/051811, filed on Jan. 25, 2024.

(30) Foreign Application Priority Data
Feb. 6, 2023 (DE) 10 2023 200 947.1

(51) Int. Cl. B60L 53/22; B60L 1/00

(52) U.S. Cl. CPC B60L 53/22; B60L 1/006; B60L 2210/42

(57) ABSTRACT

A bidirectional vehicle charging circuit with a multi-phase bridge circuit having a first, a second, and a third half bridge is provided. A first connector is connected to the first and the third half bridge. A second connector is connected to the second and the third half bridge. A controller activates the first half bridge to convert a DC voltage into a first sinusoidal signal with positively offset negative half wave with a first amplitude. The controller activates the second half bridge to convert the DC voltage into a second sinusoidal signal with positively offset negative half wave with a second amplitude. The controller activates the third half bridge to convert the DC voltage into a square wave voltage with the potentials of the DC voltage as alternating square wave voltage level. The bridge circuit, once activated, generates one sinusoidal voltage with different amplitudes at the two connectors.

### CROSS-REFERENCE TO RELATED APPLICATIONS

This application claims the benefit of PCT Application PCT/EP2024/051811, filed Jan. 25, 2024, which claims priority to German Application 10 2023 200 947.1, filed Feb. 6, 2023. The disclosures of the above applications are incorporated herein by reference.

### TECHNICAL FIELD

The disclosure relates to a bidirectional vehicle charging circuit for generating two different voltages.

### BACKGROUND

Vehicles having an electric drive have a high-voltage rechargeable battery for traction. This feeds the drive of the vehicle in a driving mode.

The energy stored in the vehicle rechargeable battery may also be used for generating a voltage which can be used by external consumers. A mobile energy source is created as a further function of the vehicle. In some examples, a vehicle charging circuit, via which the energy is transferred from an external charging current source to the rechargeable battery, may also be used for generating such a voltage for external loads, where the circuit is configured bidirectionally. Therefore, it is desirable to provide consumers with AC voltage in a variety of ways by means of such a bidirectional charging circuit.

### SUMMARY

A bidirectional vehicle charging circuit which enables the supply of AC voltage consumers, as are commonly used in the North American AC voltage supply grid for example. In some examples, a bidirectional charging circuit can be used universally if this can generate both AC voltages (for example 120 V and 240 V AC) which are commonly used in a single-phase three-wire grid, as is the case for example in the USA and Canada. In such a single-phase three-wire grid, there is a star point or neutral wire potential and two phases that are offset by 180 degrees relative to one another. Both phases have an AC voltage of 120 V effective AC voltage with respect to the neutral wire potential. In addition, for loads with higher current consumption, such as electric ovens, clothes dryers, welding devices or other electric power tools, there is the option to connect the consumer between the two phases, between which a voltage of 240 V effective AC voltage is applied. Thus, in countries having such power grids, different consumer classes are commonly used, which require different AC voltages as nominal voltage, namely 120 V and 240 V effective AC voltage.

The vehicle charging circuit described here or a corresponding on-board electrical system having such a circuit enables the supply of consumers of different nominal voltage, as are common in the USA or Canada for example, using the rechargeable battery of a vehicle as energy source. As a result, virtually any commonly used AC voltage consumer can be supplied by the vehicle. In some examples, the circuit described here enables a simultaneous supply of such consumers, for example for activities which require the simultaneous supply with both voltage levels. An example mentioned here is the operation of a welding device, a power circular saw, charging a further electric vehicle or the operation of a power pump, which require a voltage of 240 V effective AC voltage, while consumers are simultaneously supplied with a nominal voltage of 120 V effective AC voltage, for example charging devices for a rechargeable-battery-operated tool, construction site lighting or a radio. Consumers with a different nominal voltage can be operated without having to be plugged into a different socket or different, separate power paths being required.

In some implementations, a multi-phase bridge circuit of a vehicle charging circuit is used not only for the active rectification of charging alternating current, but also in the opposite direction for generating two different AC voltages starting from the DC voltage which is kept ready by a rechargeable traction battery for example. Provision is made, in the backfeed direction, in which the circuit transfers energy from a DC voltage side to AC voltage connectors, to use a first half bridge of the bridge circuit to generate a sinusoidal signal with half waves that are offset relative to one another (in the amplitude direction), the amplitude of which half waves corresponds to a first sinusoidal voltage. A second half bridge of the bridge circuit is used in order likewise to generate a sinusoidal signal with half waves that are offset relative to one another, where unlike operation of the first half bridge however, the half waves of a sinusoidal voltage correspond to a second amplitude. The sinusoidal signal referred to here is a signal with sinusoidal half waves. In the mode of operation provided here, the positive and the negative half waves are offset relative to one another. If the relevant sinusoidal half waves are not offset relative to one another, a (continuous) sinusoidal voltage results. The third half bridge is used to generate a square wave voltage. A first voltage with the first amplitude is created (as a continuous sinusoidal voltage) between the phase potential (i.e. potential on the AC voltage side of the bridge circuit) of the first half bridge and the third half bridge. A second voltage with the second amplitude is created (as a continuous sinusoidal voltage) between the phase potential of the second half bridge and the phase potential of the third half bridge.

The third half bridge is used to offset the half waves generated by the first two half bridges such that two different sinusoidal voltages (of different amplitude, but the same frequency and phase) are created between the third half bridge on the one hand and the first and second half bridges on the other hand. The third half bridge is therefore used to offset the half waves that are generated differently in terms of their voltage level depending on their polarity. The half waves that are generated or the sinusoidal signal with offset half waves that is generated by the first two half bridges creates a substantially sinusoidal (continuous) voltage together with the square wave voltage of the third half bridge. The third half bridge is thus used (at least to some extent) to “join” half waves that are offset relative to one another at the zero crossing such that a continuous sinusoidal shape is created at the zero crossing. As a result, the first two half bridges only have to generate the voltage swing from the zero crossing up to the peak voltage of the sinusoidal voltage that is to be generated (in the form of the individual half waves) and not a positive and a negative voltage swing for the two half waves of different polarity. The third half bridge can be activated using a simple square wave signal, as only the polarity has at every zero crossing of the sinusoidal voltage (between the third and the first/second half bridge). As a result, the third half bridge generates the square wave voltage. The zero crossing of the square wave voltage here corresponds to the two minima of a positive half wave (which are generated by the first two half bridges) and the maxima of a positive half wave which is to be generated by the first two half bridges.

The half waves (incl. offset) are generated by the first two half bridges by pulse wave modulation. The third half wave is conversely generated by simple switching at every zero crossing. As a result, it is possible in a simple manner to generate a first sinusoidal AC voltage and a second sinusoidal AC voltage that have different amplitudes simultaneously or at two connectors, in order thus to be able to supply consumers which are assigned to different AC voltages.

A bidirectional vehicle charging circuit is described, which has a multi-phase bridge circuit. This bridge circuit has a first, second and third half bridge. The half bridges are connected to a DC voltage side, that is to say to two DC voltage potentials. While the outer ends of the half bridges are in each case connected to the DC voltage side or the DC voltage potentials, each half bridge has a connecting point between the two switches of the respective half bridge. This connecting point corresponds to the AC voltage side of the bridge circuit and forms the phase potential of the half bridge. The bridge circuit is a B6C bridge (or a BnC bridge where n>6). The switches of the half bridge are semiconductor switches, for example transistors such as IGBTs or MOSFETs, particularly SiC MOSFETS.

The vehicle charging circuit includes a first and a second connector. The first connector is connected to the first and the third half bridges, for example to the connecting points (phase potentials) of the first and the third half bridge. The second connector is connected to the second and the third half bridges, particularly to the connecting points (phase potentials) of these half bridges.

The bridge circuit, the half bridges and the semiconductor switches thereof are power components and configured for lines of more than 3 kW or more than 10 kW in both directions. The two connectors can be designed according to a standard for plugs which are configured for operating voltages of more than 100 V, such as according to a NEMA standard (where a standard for charging sockets for electric vehicles also comes into consideration for the first connector). The first connector can additionally be designed according to a standard for designing charging plug connections or charging sockets for electric vehicles, where an adapter or an additional contact group (which is likewise connected to the first and third half bridges) is designed according to a NEMA standard.

A controller is connected in an activating manner to the half bridges, particularly to the switches of the half bridges. The controller is configured to activate at least the first and the second half bridge in a pulse-wave-modulated manner, in order thus (averaged over time) to generate a sinusoidal signal for example in the form of positive and negative half waves of a sinusoidal voltage. The controller activates the third half bridge according to a square wave signal, the two levels of which preferably correspond to the potentials of the DC voltage side. The square wave voltage is created at the third half bridge. Alternatively, the controller is configured to activate the third half bridge according to a pulse-width-modulated square wave signal, the two levels of which preferably lie between the potentials of the DC voltage side. The duty cycles of the two levels of the square wave signals are preferably the same. A square wave voltage is created as a result, the levels of which are symmetrical to the potential that lies in the middle between the two potentials of the DC voltage (on the DC voltage side). The duty cycle of the square wave signal for generating the square wave voltage is, for example, constant within a pulse of the square wave voltage (corresponding to the duration of a half wave).

The controller is configured to convert a DC voltage on the DC voltage side of the bridge circuit into a sinusoidal signal, such as into successive positive and negative sinusoidal half waves, by pulse wave modulation. The first and the second half bridge are used for this. The successive sinusoidal half waves have alternating polarities and are preferably offset relative to one another, by the voltage swing with which the third half bridge is activated (i.e. are offset by the difference between the two levels of the square wave voltage). The controller is configured also to activate the third half bridge, in order, at least in one mode, to activate the third half wave using a square wave signal for generating the square wave voltage. The edges of the square wave voltage may coincide with times at which two half waves of the first and second half bridges follow one another. Half wave here only refers to the shape of the profile within a half period and not necessarily the reference to a zero line. A half wave can therefore start from a first potential of the DC voltage, a second potential of the DC voltage, from a zero line or else from an arbitrary voltage level.

The controller is configured to convert the first half bridge to convert the DC voltage on the DC voltage side of the bridge circuit into a sinusoidal signal with positive and negative half waves. Here, only the shape of the half waves is described, but not the voltage levels thereof. This sinusoidal voltage has a positively offset negative half wave. A negative half wave refers to a sinusoidal half wave which extends from a baseline in the negative direction. The negative half wave has a profile which corresponds to a sinusoidal profile with an angular range between 180° and 360°. The negative half wave (i.e. the baseline) is positively offset, that is to say is offset toward a positive potential of the DC voltage. In some examples, the negative half wave starts with the positive potential of the DC voltage. The negative half wave starts with the positive edge of the square wave voltage of the third half bridge. The controller is configured to activate the first half bridge to generate a positively offset negative half wave with a first amplitude. The controller is further configured also to convert the second half bridge to convert the DC voltage into a sinusoidal signal with positive and negative half waves. The negative half wave is also positively offset here. However, the negative half wave generated by the second half bridge has a second amplitude which differs from the first amplitude of the first half bridge. As a result, the first and the second half bridge are activated by the controller in order to generate a sinusoidal signal with positive and negative half waves in each case, where the amplitudes of the sinusoidal voltage (first amplitude and second amplitude) differ however, and where the negative half wave of the pulsing sinusoidal voltage is positively offset. In some examples, the controller is also configured to generate the positive half wave of the pulsing sinusoidal voltage of the respective (first or second) half bridge. In some examples, the positive half wave starts from the negative potential of the DC voltage or else from the negative level of the square wave voltage of the third half bridge (while the negative half waves of the first and second half bridges start from the positive level of the square wave voltage of the third half bridge).

The sinusoidal signal which is generated by the controller and the first and second half bridges alternately has positive and negative half waves. The positive half wave corresponds (apart from the position of the baseline) to a sinusoidal profile of 0° to 180°. A negative half wave corresponds (apart from the position of the baseline) to a sinusoidal profile of 180° to 360°. The positive or negative half waves are offset (in the amplitude direction) relative to one another. In some examples, the positive half wave is offset toward the negative potential of the DC voltage, while the negative half wave is offset toward the positive potential. If the DC voltage which is applied in the half bridge (on the DC voltage side) includes the voltage between the potentials DC− (negative potential) and DC+ (positive potential), then the positive half wave starts from the potential DC− and is therefore offset toward this potential. The negative half wave starts from the potential DC+ and is therefore offset toward same. The amplitudes of the half waves or the amplitude of the pulsing sinusoidal voltage are or is smaller than the level of the DC voltage (difference between the potentials DC+, DC−). The voltage generated by the first and second half bridge in each case can be represented by:

$$for x = 0 ° … 180 ° : DC - + A \cdot sin ( x ) ( = positive half wave ) and$$

$$for x = 180 ° … 360 ° : DC + - A \cdot sin ( x ) ( = negative half wave )$$

where:
A=amplitude of the half waves,
x=phase angle of the half waves, and
DC+, DC−: potentials of the DC voltage on the DC voltage side of the bridge circuit.

This applies for the sinusoidal voltage of the first and the second half bridge, where the amplitudes A of the two half bridges differ. The amplitude offset between positive and negative half wave corresponds to the difference of DC− and DC+.

The controller is additionally configured to activate the third half bridge to convert the DC voltage into a square wave voltage with the potentials of the DC voltage. An alternating square wave voltage level is created. The controller is thereby configured to activate the bridge circuit to generate one sinusoidal voltage with different amplitudes in each case at the two connectors. The sinusoidal voltage generated at the connectors by this has continuous half waves. In other words, the half waves are not offset relative to one another (based on the amplitude), but rather merge with one another at the transitions between the half waves essentially without a sudden (instantaneous amplitude) change. This is enabled by the square wave voltage of the third half bridge, the swing of which is complementary to the offset of the two half waves of different polarity which are generated by the first and the second half bridge.

The first and second sinusoidal signal therefore refer to signals which, like a sinusoidal voltage, have two half waves of different polarity, where the half waves are offset relative to one another however. A sudden potential or voltage change results in the sinusoidal signals in each case at the transition between successive half waves of different polarity. A sinusoidal voltage refers to a continuous voltage which can possibly have an (amplitude) offset with respect to a differential potential, at which successive half waves of different polarity merge with one another essentially without a sudden change, however. The sinusoidal signal may also be a signal of a voltage, but referred to using a different term to distinguish it with respect to a sinusoidal voltage (with “smooth” transitions that are free from sudden changes between the half waves).

The controller is configured to activate the three half bridges such that at the connectors two sinusoidal signals are created at the two connectors (without a sudden transition between the half bridges), which sinusoidal signals have a different amplitude. This is achieved in that the signal generated in each case by the third half bridge at the connectors is combined with the signal of the first half bridge or the second half bridge to form a sinusoidal voltage with an amplitude (that is free from sudden changes). The two amplitudes of the sinusoidal voltages at the two connectors differ, so that consumers with different nominal voltages can be operated simultaneously.

In some implementations, it is possible that consumers with a first nominal voltage can be connected to the first connector and consumers with a second nominal voltage can be connected to the second connector, so that both can be operated (either alternately or else simultaneously) without the operating voltage of consumers having to be changed and without consumers having to be plugged into a different socket. The two connectors are connected to the half bridges such that in the case of the activation of the half bridges at the connectors described here, one sinusoidal voltage would arise in each case (without sudden changes when changing between the half waves of different polarity). Both connectors are on the one hand connected to the third half bridge which is activated by the controller to generate a square wave voltage. Here, the two switches of the third half bridge are alternately switched on or off, where the switch state remains for the period of a square wave and also for the period of a sinusoidal half wave. Furthermore, the first connector is connected to the first half bridge and the second connector is connected to the second half bridge, so that, in the case of a pulse-width modulated activation of these half bridges using a negative half wave that is offset the toward the positive potential, different voltages are also generated with respect to the third half bridge at different amplitudes of the half bridges. As a result, the sinusoidal voltages are created with different amplitudes. The first and the second half bridge in each case generate a sinusoidal signal having a first or second amplitude. The amplitude of this sinusoidal signal, the negative half wave of which is shifted toward the positive potential (and the positive half wave of which is shifted toward the negative potential), refers to the amplitude of the maximum voltage difference within a half wave (and not the maximum voltage difference of all half waves). In other words, the term amplitude of the sinusoidal signals that are described here refers to the amplitude of an individual half wave and not to the total amplitude which would additionally also include the voltage swing (sudden voltage change) between the positive and the negative half wave.

In some implementations, the controller is configured to activate the bridge circuit to generate a first sinusoidal voltage at the first connector and simultaneously to generate a second sinusoidal voltage at the second connector. In this case, the first and the second half bridge are operated simultaneously in order to generate a respective sinusoidal signal, as a result of which it becomes possible to supply two different sinusoidal voltages simultaneously at the two connectors. In alternative states, the controller can be configured either to activate the first half bridge or the second half bridge to generate the respective sinusoidal voltage, so that consumers having different nominal voltages can be connected to the two connectors, where it becomes possible to operate these consumers without plugging into a different socket at the connectors.

In some examples, the amplitude of the first voltage at the first connector is approximately double the amplitude of the second voltage at the second connector. The first voltage is therefore approximately double the second voltage. In some implementations, the amplitude or the voltage can be approximately double in that the first voltage is 1.8- to 2.2-times the second voltage. The amplitude of the first voltage signal can likewise be approximately double the amplitude of the second sinusoidal signal. In other words, the amplitude of the first sinusoidal signal can be 1.8- to 2.2-times the amplitude of the second sinusoidal signal. The negative and the positive half wave of the first voltage have the same amplitude. The positive and the negative half wave of the second sinusoidal signal also have the same amplitude.

The voltage swing of the half waves of the first sinusoidal voltage may correspond to 1.8- to 2.2-times the voltage swing of the half waves of the second sinusoidal voltage. In other words, the amplitude of a half wave of the first sinusoidal voltage is approximately double the amplitude of a half wave of the second sinusoidal voltage. The voltage swing of the square wave voltage level is at least as large as the voltage swing of a half wave of the first sinusoidal voltage (and also at least as large as the voltage swing of a half wave of the second sinusoidal voltage). This also applies for the voltage swing of the half waves in the first and the second sinusoidal signal. In some examples, the voltage swing of the square wave voltage (of the third half bridge) corresponds to the DC voltage which is applied on the DC voltage side of the half bridges.

The voltage swing of the square wave voltage, that is to say the voltage between the two levels of the square wave voltage, and the offset of the positive and negative half waves in the first and in the second sinusoidal signal are configured such that one sinusoidal signal in each case is created at the connectors by the voltage swing of the square wave voltage without sudden (amplitude) changes between the successive half waves. In some examples, the voltage offset between the half waves of different polarity in the first and in the second sinusoidal signal approximately corresponds to the voltage swing of the square wave voltage, in order thus to enable a transition between successive half waves (which have different polarities) which is substantially free from sudden changes.

The negative half waves of the first sinusoidal voltage have an offset which substantially corresponds to the positive offset of the negative half waves of the second sinusoidal signal. In some examples, in both sinusoidal signals at the transition of successive half waves, the half waves are offset relative to one another by a potential difference which substantially corresponds to the voltage swing of the square wave voltage. Depending on the reference potential, it may also be provided for the positive half waves to have an offset, namely a negative offset. In some implementations, the zero line of the positive half waves of the sinusoidal signals corresponds to the negative potential of the DC voltage (or the negative level of the square wave voltage) and the zero line of the negative half waves of the sinusoidal signals corresponds to the positive potential of the DC voltage (or the negative level of the square wave voltage). An offset between the half waves is created, which corresponds to the DC voltage level (or the difference between the levels of the square wave voltage).

In one way of looking at things, which assumes that the positive half wave undergoes no offset and starts from the negative potential as zero line, the negative half wave has a positive offset which corresponds to the DC voltage or the voltage swing of the square wave voltage. In one way of looking at things, which assumes a zero line or a differential potential in the middle between the two potentials of the DC voltage, the positive half wave has a negative offset which corresponds in terms of magnitude to the positive offset of the negative half wave. The sum of the magnitudes of the offset of the positive half wave and the offset of the negative half wave corresponds to the potential difference of the DC voltage (such as corresponding to the level of the DC voltage) and for example, corresponds to the voltage swing of the square wave voltage that is generated by the third half bridge.

The positive half waves of the first sinusoidal signal and the positive half waves of the second sinusoidal signal start and end at the same time. This also applies to the negative half waves. In some examples, the half waves of the sinusoidal signals are synchronous with the edges of the square wave voltage. The transition between the half waves in the sinusoidal signals occurs simultaneously with the edges of the square wave voltage. The edges of the square wave voltage correspond to the transition between the different levels of the square wave voltage, so that the transitions which are generated in the signal of the third half bridge are synchronous or isochronous with the transitions between the half waves in the sinusoidal signals of the first and second half bridge.

In some implementations, the controller is configured to activate the bridge circuit to generate a sinusoidal voltage of essentially 240 V at the first connector. The controller is further configured to activate the bridge circuit to generate a sinusoidal voltage of essentially 120 V at the second connector. In some examples, the controller is configured to activate the bridge circuit to generate a sinusoidal voltage with a frequency of 60 Hz. The controller may also be configured to activate the first and the second half bridge to generate half waves with a frequency of 60 Hz. In other words, the period of a half wave, as is generated by the first and the second half bridge, corresponds to the period of a sinusoidal wave of 60 Hz. The addition “essentially” in front of a value means a maximum deviation of the mentioned value of not more than 20, 10, 5 or 2%. In some examples, the controller is configured to generate an AC voltage at the two connectors, which corresponds to the standard NFPA 70 (i.e. the usual standard in North America at the low-voltage level in the public power supply grid).

The bidirectional vehicle charging circuit that is described is used for generating sinusoidal voltages at the two connectors, starting from a DC voltage at the bridge voltage. A further function is the (controlled) rectification of AC voltage which is applied at least at one of the connectors, in order to convert this AC voltage into a DC voltage. As a result, a rechargeable battery in the vehicle can be charged by way of an external alternating current source. The controller can therefore, in a charging state, be configured to activate the bridge circuit for the (controlled) rectification of an AC voltage which is applied at the first connector, in order therefore to generate a DC voltage on the DC voltage side of the bridge circuit, particularly according to a setpoint DC voltage. Such a charging state implements the previously mentioned function. The AC voltage applied at the first connector can be a single-phase AC voltage or can be provided by a plurality of voltages of a single-phase three-wire grid, that is to say by a multi-phase voltage, where the individual phases correspond to the individual voltages of a single-phase three-wire grid.

The vehicle charging circuit can have individual inductors, by way of which a first phase potential, a second phase potential and a neutral wire potential of the first and the second connector are connected to the half bridges (such as the intermediate points of the half bridges). The controller can, in a charging state, be configured to operate the bridge circuit together with the individual inductors as a power factor correction circuit (PFC). The first half bridge can be connected via a first inductor to a second phase potential. The second phase potential can also be referred to as an L2 potential and is part of the first connector, for example realized as a second phase contact of the first connector. The second half bridge can be connected via a second inductor to a neutral wire potential. The neutral wire potential may be part of the second connector and/or is part of the first connector. The neutral wire potential can be realized as a neutral wire contact in the respective connector. The third half bridge can be connected via a third inductor to the first phase potential. The first phase potential is part of the first and/or of the second connector. Within the respective connector, the first phase potential can be realized as a first phase contact of the respective connector. The connectors can furthermore have a protective conductor contact or a protective conductor potential.

The first connector can be designed in accordance with a NEMA socket for 240 V alternating current. The second connector can be designed in accordance with a NEMA socket for 120 V. In some examples, the first connector can be designed according to one of the standards: NEMA (L) 5-15, -20, -30, -50 or NEMA 1-15. The second connector may be designed according to one of the standards NEMA (L) 6-15, -20, -30, -50. The first and/or the second connector can be designed according to the standard NEMA (L) 14-20, -30, -50 or -60.

In some implementations, the disclosure provides a vehicle charging circuit having a changeover switch which optionally connects the second half bridge to a neutral wire potential of the second connector or to a phase potential of the first connector. This phase potential of the first connector is that which is connected to the first half bridge (for example to its connecting point). If the changeover switch is in a first switching position, then the changeover switch connects the second half bridge (or its connecting point) to the second phase potential (L2) of the first connector. In a second switching position, the changeover switch connects the second half bridge (that is to say its connecting point) to a neutral wire potential of the second connector. The second connector has a neutral wire potential, where a neutral wire potential may or may not be provided in the first connector.

The vehicle charging circuit can have a disconnector which is provided between the second connector and the third half bridge. In some examples, the disconnector is connected between an inductor, which is connected to the third half bridge, and the first phase potential of the second connector.

The vehicle charging circuit can have an insulation monitor. This has inputs which are connected to the first phase potential, the second phase potential and the neutral wire potential of the connectors. In some examples, the insulation monitor is connected to the first phase potential of the second connector by the disconnector. In other words, the insulation monitor is not connected to the third bridge by the disconnector. The insulation monitor is preferably connected to the half bridges by the inductors. The insulation monitor can be connected to the neutral wire, where the connecting point that is created is connected to the second half bridge by the changeover switch. If both connectors have a neutral wire potential, these can be connected to one another. The second connector may be a socket inside the vehicle. The second connector can be designed as a charging socket that is configured for charging electric vehicles by way of an external charging voltage source. Here, the first connector for outputting an AC voltage can have an adapter which is designed according to one of the aforementioned NEMA standards for 240 V alternating current. Therefore, the first connector can be in two parts and can have a charging socket and furthermore an adapter which can be plugged into the charging socket and which further makes it possible to connect a commonly used 240 V consumer.

The vehicle charging circuit can have a DC-to-DC voltage converter. This is connected downstream of the DC voltage side of the bridge circuit. The vehicle charging circuit can have a rechargeable-battery-to-on-board-electrical-system-branch connector. This is connected to the DC voltage side of the bridge circuit by a DC-to-DC voltage converter. A high-voltage rechargeable traction battery of the vehicle can be connected to the rechargeable-battery-to-on-board-electrical-system-branch connector.

Furthermore, the disclosure provides an on-board electrical system i, which has a bidirectional vehicle charging circuit as is described here. The on-board electrical system additionally has a high-voltage rechargeable battery, such as a high-voltage rechargeable traction battery. This is connected to a rechargeable-battery-to-on-board-electrical-system-branch connector of the vehicle charging circuit. The rechargeable-battery-to-on-board-electrical-system-branch connector can be connected directly or indirectly to the direct current side of the bridge circuit. The rechargeable-battery-to-on-board-electrical-system-branch connector can be connected to the high-voltage rechargeable battery directly (without a converter) or via a (galvanically isolating or non-isolating) DC-to-DC voltage converter. Instead of the high-voltage rechargeable battery, the on-board electrical system can also generally have an on-board electrical system branch which has a high-voltage battery system and which is connected, as described here, to the rechargeable-battery-to-on-board-electrical-system-branch connector.

The circuit described here enables the supply of AC voltages as are commonly used in the North American supply grid. Two different voltage levels are supplied by a single circuit at least at two different connectors. As a result, various consumers can optionally be supplied with different nominal voltages simultaneously or—without unplugging. This relates to 120 V consumers and 240 V consumers. One of the connectors can be designed as a charging connector, where a conventional socket or conventional socket contacts for 240 V is or are provided by an adapter which can be plugged into the charging socket. The adapter therefore has two ends, where one end is configured to be plugged into a charging socket of an electric vehicle and the other end forms a socket, such as for 240 V consumers. Instead of an adapter, a socket can also be provided, which is connected parallel to the charging socket, where this parallel connection is then connected to the bridge circuit as a second connector.

The circuit presented here is a charging device in the vehicle (on-board charger, OBC), by way of which a power factor correction filter can be formed. To this end, in addition to the half bridges, (individual) inductors are also provided, which together with the half bridges represent a controlled rectifier which is additionally used as a power factor correction filter. During operation in the opposite direction, a DC voltage on the DC voltage side is converted by the bridge circuit into two different AC voltages (sinusoidal voltages), as is presented here.

Between a half bridge, such as the second half bridge, and the connectors, it is possible to provide a single-pole changeover switch (ON-ON) (SPDT). The connector on the half bridge side is optionally connected to the first connector or the second connector. In some examples, the changeover switch optionally connects the second half bridge to the phase L2 of the first connector or to the neutral wire potential or neutral wire contact of the second connector. In the case of a chosen connection of the second half bridge to the first connector (phase L2), the second half bridge is connected parallel to the first half bridge, so that a higher current can be generated at the first connector. The first voltage is then created at the first connector, where the first and the second half bridge contribute to converting this voltage however and thus a higher current is possible. If the changeover switch connects the second half bridge to the second connector (neutral wire potential), then different sinusoidal voltages can be generated simultaneously at both connectors. The second half bridge is then used for generating the second voltage at the second connector and the first half bridge is used for generating the first (higher) sinusoidal voltage at the first connector.

The disconnector between the third half bridge and the second connector (its L1 phase potential), which disconnector is described here, can be configured for a maximum voltage which is less than the first voltage, that is to say which corresponds to the second voltage. Both the first and the second connector can have an L1 phase (particularly as a contact), where these are connected to one another. The connection between these phases is preferably on the side of the disconnector which is connected to the half bridge.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic view of a bidirectional vehicle charging circuit described here and of the on-board electrical system described here.

FIG. 2 shows a schematic view of the voltages of the three half bridges and is used to explain the activation of the bridge circuit.

Like reference symbols in the various drawings indicate like elements.

### DETAILED DESCRIPTION

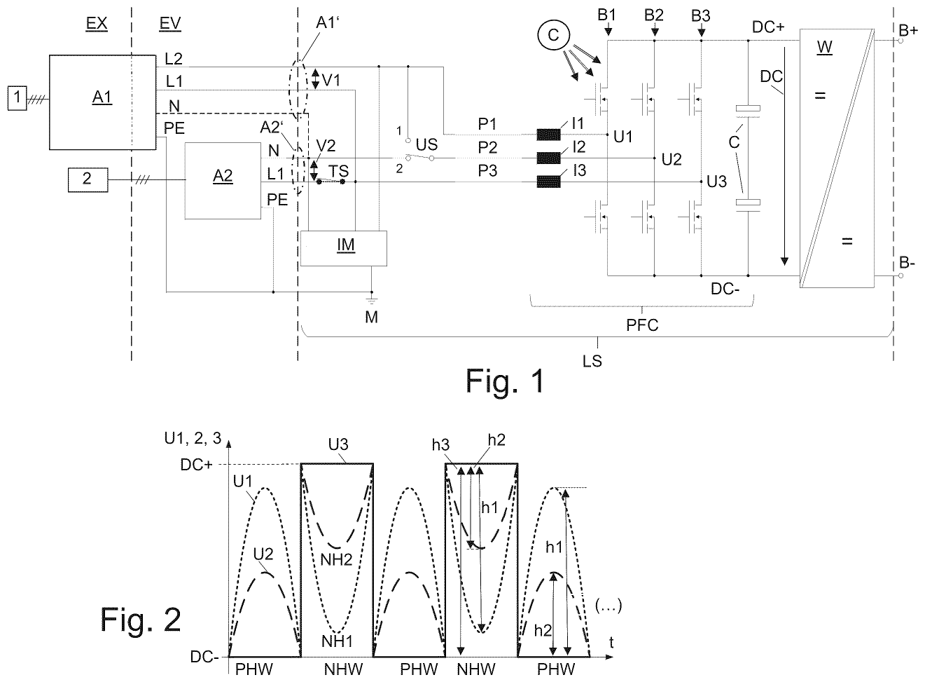

FIG. 1 shows a charging circuit LS inside an electric vehicle, which is connected to an in-vehicle interface EV in order to be able to connect external devices EX in this manner. The charging circuit LS has a first connector A1′ which is connected to a connection device A1, to which a consumer 1 is in turn connected by way of example. The charging circuit further has a second connector A2′ which is connected to an in-vehicle connection device A2. Since the connectors are directly connected to the respective connection devices and thus identical potentials are created, no distinction is made between connection device and connector for the simplified illustration of the electrotechnical relationships. In an electromechanical implementation, the connectors A1′ and A2′, which are parts of the power circuit, can be designed as (internal) connecting elements or screwed connection elements or can be formed by continuous conductors which extend from the interior of the vehicle circuit LS outward to the connection devices A1 and A2. The first connector A1 can, as illustrated, be in two parts with a vehicle charging socket as (a part of the) interface in the vehicle and with an adapter that is plugged into same. The adapter has one end configured for plugging into the charging socket of the vehicle and one second end, which is connected thereto and which forms a socket for a consumer (such as for a 240 V consumer). The socket may be designed according to one of the standards NEMA (L) 6-15, -20, -30, -50 according to the standard NEMA (L) 14-20, -30, -50 or -60.

The bidirectional vehicle charging circuit has a bridge circuit having three half bridges B1, B2, B3. Each half bridge has two series-connected transistors which are interconnected by way of connecting points U1, U2, U3 and the ends of which are connected to DC voltage potentials DC+, DC− of the DC voltage side of the bridge circuit. The connecting points between the transistors of each half bridge have a potential which is labeled with the same reference sign U1 to U3 for improved clarity. By way of a galvanically (isolated) DC-to-DC voltage converter W, which is optional, the DC voltage side of the bridge circuit (and thus the DC voltage potentials DC+, DC−) is connected to an on-board electrical system branch connector B+, B−. The on-board electrical system branch connectors B+, B− are part of the charging circuit and are configured to be connected to in-vehicle circuits, for example to a high-voltage rechargeable battery or to a rechargeable-battery-to-on-board-electrical-system branch. The connectors B+, B− are also referred to as rechargeable-battery-to-on-board-electrical-system-branch connectors. An intermediate circuit capacitor C, which here has two series-connected capacitors by way of example, is likewise connected to the DC voltage side of the bridge circuit (half bridges B1 to B3).

The potentials or connecting points U1, U2, U3 of the half bridges B1 to B3 form an AC voltage side of the bridge circuit. The AC voltage side is connected by way of three (individual) inductors I1 to I3 to the connectors A1, A2 or A1′, A2′. One of the inductors I1 to I3 is connected in each case between each of the connecting points U1 to U3 (that is to say each of the AC voltage potentials of the AC voltage side of the bridge circuit) and the connectors A1, A2 or A1′, A2′. The inductors I1 to I3 form a power factor correction filter PFC together with the bridge circuit B1 to B3.

The operating principle with closed disconnector TS and a changeover switch US, which is in the switching position 2, as illustrated, is considered hereinafter. A mode of operation is considered, in which the bridge circuit B1 to B3 is activated by the controller C to convert the voltage on the DC voltage side (DC+, DC−) to an AC voltage at the first and second connectors A1, A1′; A2, A2′. The controller C activates the switches or transistors of the bridge circuit B1 to B3 as follows:

The first half bridge is activated for converting the DC voltage DC on the DC voltage side of the bridge circuit to a first sinusoidal signal with a positively offset negative half wave. The half waves of the sinusoidal signal have a first amplitude. This is illustrated with NH1 in FIG. 2. The first sinusoidal signal has positive half waves which relate to the negative potential DC− of the DC voltage. One way of looking at things is that the positive half waves are also offset, namely negatively. Instead of the considerations of the individual offset of the individual half waves, the curve shape can also be represented by a sinusoidal signal with positive half waves PHW and negative half waves NHW which are offset relative to one another. In some implementations, these half waves are offset relative to one another by a square wave voltage U3, which is generated by the third half bridge. The second sinusoidal signal U2 is generated in the same way as the first sinusoidal signal and, except for the amplitude, has the same signal properties as the first sinusoidal signal. It can be seen with reference to FIG. 2 that the second sinusoidal signal has a positively offset negative half wave H2. In some examples, the positive and the negative half waves of the second sinusoidal signal are offset relative to one another. As also in the case of the first sinusoidal signal, the negative half wave is positively offset with respect to the positive half wave in the second sinusoidal signal. The offset between the half waves of different polarity in the second sinusoidal signal corresponds to the offset between the different half waves in the first sinusoidal signal. The offset between the half waves of different polarity in the first sinusoidal signal corresponds to the swing of the square wave voltage U3. This also applies to the second sinusoidal signal U2. The swing or the offset between the levels in the square wave voltage H3 is greater than the amplitude H1, H2 of the half waves of the sinusoidal signals. The swing illustrated in FIG. 2 or the amplitude of the square wave voltage (voltage difference between the two levels within the square wave voltage) corresponds to the DC voltage DC, that is to say the difference between the potentials DC+, DC−.

Furthermore, FIG. 2 illustrates that the voltage U2 has an amplitude which corresponds approximately to double the amplitude of the voltage U2. In some examples, the voltage U1 has an amplitude of a sinusoidal wave which corresponds to an effective AC voltage of 240 V. The voltage U2 has an amplitude of an AC voltage which corresponds to an effective value of 120 V alternating current. The sinusoidal voltage V1 at the first connector is between the phases L1 and L2 of the first connector. The voltage is created by the combination of the potentials U1 and U3 or between the phase potentials P1 and P3 on the sides of the inductors I1 and I3 which face the connectors A1, A2. With respect to FIG. 2, this means that the voltage V1 corresponds to the potential difference U1, U3. In the case of the positive half wave, this means a positive half wave with the amplitude H1, and for the negative half wave, this means an amplitude H1 (negative half wave), where the two half waves join together without a sudden change. The transition, which is free from sudden changes, results in that the half waves PHW, NHW of the first sinusoidal signal U1 are offset in the same way at the transition between the half waves or jump at the transition between the half waves like the potential of the square wave voltage. The second sinusoidal voltage V2 is created by the potential difference between the signals U2, U3 of the second and third half bridges B2, B3. Here also, the second sinusoidal signal jumps at the transition between the half waves just as the level in the square wave voltage changes synchronously to this. Here also, a (continuous) sinusoidal wave or a sinusoidal voltage V2, which essentially has no sudden change, is then created. Therefore, the offset between the half waves or the offset of the negative half wave is counterbalanced in the sinusoidal signals by the square wave voltage.

In a charging state, an AC voltage can be applied at the first connector A1 or A1′, which is rectified in a controlled manner by the three half bridges B1-B3 and the inductors I1 to I3, in order thus to generate the voltage DC. DC can be forwarded to the connector B+, B− directly or via the optional converter W, in order thus to charge a rechargeable battery that can be connected thereto. This operation corresponds to the customary equalizing operation which is brought about by the power factor correction filter PFC.

In the conversion or power conversion of the voltage DC into the AC voltage V1, V2 there are, inter alia, two different states. In the first state, there is a changeover switch which connects the second half bridge B2 or inductor 12 (and thus the phase connector P2 of the bridge circuit), which is connected thereto, to the second phase L2 of the first connector A1. In this state, B1 and B2 operate synchronously and in the same way, in order thus to be able to carry double the current and as a result to generate a voltage V1 which can be output with a high current. In this state, the disconnector TS can be open, in order to avoid an interfering voltage being applied at the second connector. In a further state, the changeover switch US is in the switching position 2. In this case, the first half bridge is connected to the second phase connector L2, the first phase L1 of the first and second connector is connected to the third half bridge and the neutral wire potential N of the connectors A1, A2 (or A1′, A2′) is connected to the second half bridge. The connection to the half bridges takes place here via their AC voltage sides, that is to say via the connecting points U1 to U3. In this case, the first half bridge is activated for generating the first sinusoidal signal, and the second half bridge is activated for generating the second sinusoidal signal, the half waves of which have a smaller amplitude than the half waves of the first sinusoidal voltage. Two different sinusoidal voltages are then created (at the half wave transition, in a manner free from sudden changes) at the connectors A1 and A2. This enables a simultaneous supply of the consumers 1, 2 which have different nominal voltages. In some examples, a voltage of 240 V effective AC voltage can then be generated at the connector A1, in order to supply the consumer 1 that is compliant with that. A voltage of 120 V effective AC voltage can be generated at the connector A2, in order to supply the consumer 2 which has this voltage as nominal voltage. In this state, the disconnector TS is closed in order to enable voltage output at the connector A2 or A2′.

An insulation material IM has inputs which are connected to the phases L1, L2 and to the neutral wire potential N and a protective conductor potential M. If the optional disconnector TS is present, then the insulation monitor IM is preferably connected to the side of the disconnector which is also connected to the third half bridge or bridge circuit or the inductors I1 to I3 that are connected upstream. The input, which is connected to the phase L2, is preferably connected on the side of the changeover switch US to the phase L2 which faces the first connector A1. The insulation monitor IM can be connected in an activating manner to the controller C, in order to open all of the switches of the half bridges B1 to B3 permanently in the event of a detected insulation fault. The controller C is preferably connected in an activating manner to the changeover switch US and/or the disconnector TS.

FIG. 2 shows, as mentioned by way of example, the two sinusoidal signals which differ from a pure sinusoidal wave in that the successive half waves that differ in polarity are offset relative to one another (in terms of amplitude). The positive half wave PHW is offset negatively with respect to the negative half wave NHW. The offset corresponds to the swing or the amplitude of the square wave voltage U3. The voltages U1 to U3 are plotted with respect to the potential DC− and correspond to the potentials at the connecting points of the three half bridges B1 to B3. Only the square wave voltage U3 that is shown has two voltage levels which alternate between DC+ and DC−. The sinusoidal signals U1, U2 have a smaller amplitude (H1, H2). The square wave voltage U3 is generated by alternate opening and closing of the switches of the half bridge B3. The switching state remains constant within a half wave (period). In contrast to this, one sinusoidal half wave is generated in each case by way of pulse wave modulation (by the controller C) by the first half bridge B1 and the second half bridge B2. The resulting envelope curve of the signals of the half bridges B1 and B2, which signals are created by the pulse width modulation, has the same period as the square wave voltage. In other words, the sinusoidal waves of the sinusoidal signals and the square wave voltage are synchronous and of equal length. For example, the sinusoidal signals and the square wave voltage have a frequency of 60 Hz (or else of 50 Hz).

A number of implementations have been described. Nevertheless, it will be understood that various modifications may be made without departing from the spirit and scope of the disclosure. Accordingly, other implementations are within the scope of the following claims.

What is claimed is:

1. A bidirectional vehicle charging circuit comprises:
a multi-phase bridge circuit including a first, a second, and a third half bridge;
a first connector connected at least to the first and the third half bridge;
a second connector connected at least to the second and the third half bridge; and
a controller connected to the first, second, and third half bridges in an activating manner and is configured to activate the first half bridge to convert a DC voltage on DC voltage side of the bridge circuit into a first sinusoidal signal with positively offset negative half wave with a first amplitude, to activate the second half bridge to convert the DC voltage into a second sinusoidal signal with positively offset negative half wave with a second amplitude, and to activate the third half bridge to convert the DC voltage into a square wave voltage with potentials of the DC voltage as alternating square wave voltage level,
wherein the controller is thereby configured to activate the bridge circuit to generate one sinusoidal signal with different amplitudes in each case at the two connectors.

2. The bidirectional vehicle charging circuit of claim 1, wherein the controller is configured to activate the bridge circuit to generate a first sinusoidal voltage at the first connector and simultaneously to generate a second sinusoidal voltage at the second connector.

3. The bidirectional vehicle charging circuit of claim 1, wherein the amplitude of a first voltage at the first connector, which is applied at two phase potentials of the first connector, is 1.8-times to 2.2-times the amplitude of a second voltage at the second connector, which is applied between a phase potential and a neutral wire potential of the second connector.

4. The bidirectional vehicle charging circuit of claim 1, wherein the voltage swing of the half waves of the first sinusoidal voltage corresponds to 1.8-times to 2.2-times the voltage swing of the half waves of the second sinusoidal voltage and the voltage swing of the square wave voltage corresponds to the voltage swing of the half waves of the first sinusoidal voltage or is greater than same.

5. The bidirectional vehicle charging circuit of claim 1, wherein the negative half waves of the first and the second sinusoidal signals have the same positive offset, wherein this offset corresponds to the potential difference between the square wave voltage levels of the square wave voltage.

6. The bidirectional vehicle charging circuit of claim 1, wherein the positively offset negative half waves of the first and second sinusoidal signals start and end simultaneously at times at which edges of the square wave voltage occur.

7. The bidirectional vehicle charging circuit of claim 1, wherein the controller is configured to activate the bridge circuit to generate a sinusoidal voltage of essentially 240 V at the first connector and to generate a sinusoidal voltage of 120 V at the second connector, wherein the sinusoidal voltages have a frequency of 60 Hz.

8. The bidirectional vehicle charging circuit of claim 1, wherein, in a charging state, the controller is configured to activate the bridge circuit for rectification of an AC voltage which is applied at the first connector to a DC voltage on the DC voltage side of the bridge circuit.

9. The bidirectional vehicle charging circuit of claim 1, wherein the half bridges are connected by individual inductors to a first phase potential, a second phase potential, and a neutral wire potential of the first and the second connector, wherein the controller is, in a charging state, configured to operate the bridge circuit together with the individual inductors as a power factor correction circuit.

10. The bidirectional vehicle charging circuit of claim 1, further comprising a changeover switch which optionally connects the second half bridge to a neutral wire potential of the second connector or to a phase potential of the first connector, which is connected to the first half bridge.

11. The bidirectional vehicle charging circuit of claim 1, further comprising a disconnector provided between the second connector and the third half bridge.

12. The bidirectional vehicle charging circuit of claim 1, further comprising an insulation monitor which is connected to the phase potentials and the neutral wire potential of the first and the second connector.

13. The bidirectional vehicle charging circuit of claim 1, wherein a DC-to-DC voltage converter is connected downstream of the DC voltage side of the bridge circuit, which connects the bridge circuit to a rechargeable-battery-to-on-board-electrical-system-branch connector of the vehicle charging circuit.

14. An on-board electrical system having the bidirectional vehicle charging circuit of claim 1, wherein the on-board electrical system further has a high-voltage rechargeable battery which is connected to a rechargeable-battery-to-on-board-electrical-system-branch connector of the vehicle charging circuit directly or via a DC-to-DC voltage converter.
